(19) United States
(12) Patent Application Publication
(10) Pub. No.: US 2017/0360252 A1
(43) Pub. Date: Dec. 21, 2017

(54) COOKING VESSEL MADE OF ANODIZED ALUMINUM ALLOY

(71) Applicant: SEB S.A., ECULLY (FR)

(72) Inventors: Laurent AUBIN, Rumilly (FR); Stéphane TUFFE, Cognin (FR)

(21) Appl. No.: 15/540,880

(22) PCT Filed: Dec. 18, 2015
(86) PCT No.: PCT/FR2015/053640

§ 371 Date: Jun. 29, 2017

(30) Foreign Application Priority Data
Dec. 30, 2014 (FR) 1463447

(51) Int. Cl. A47J 36/02; A47J 45/06

(52) U.S. Cl. CPC A47J 36/025; A47J 45/061

(57) ABSTRACT

A cooking vessel includes a molded pan made of aluminum casting alloy. The aluminum casting alloy used includes at least 94.5 mass % of aluminum and a cumulated content of between 4 and 5 mass % for the following elements: silicon, manganese, magnesium, nickel. The pan is at least partially anodized. The thickness of the anodized layer of the pan is higher than, or equal to, 25 μm.

This invention concerns the technical field of cooking appliances and utensils including a cooking vessel.

This invention concerns more specifically, but not exclusively, cookware such as pots, pans or woks, as well as electric cooking appliances including a reservoir intended to hold food.

It is known to produce cooking vessels in die-cast aluminum alloy, notably in AS12 alloy, also called AlSi12 (aluminum casting alloy including 12% silicon). This alloy may be used bare. This alloy may also be used with a non-stick coating such as PTFE. The non-stick coating may notably cover the inner cooking face of the cooking vessel. The non-stick coating may also notably cover the side wall of the outer face of the cooking vessel.

In such cooking vessels made of die-cast aluminum alloy, one drawback of non-coated surfaces resides in the adhesion of food and/or grease, which makes cleaning such cooking vessels difficult.

The use of a non-stick coating such as PTFE provides non-stick properties. However, such a non-stick coating proves to be susceptible to scratching.

One object of this invention is to propose a cooking vessel including a molded reservoir made of aluminum casting alloy, in which the cleaning of the outer wall of the cooking vessel is facilitated without necessitating the use of a non-stick coating.

Another object of this invention is to propose a cooking vessel including a molded reservoir made of aluminum casting alloy, in which the walls have a uniform appearance without necessitating a coating.

An additional object of this invention is to propose a cooking vessel including a molded reservoir made of aluminum casting alloy with a non-stick coating, in which the scratch-resistant properties of the non-stick coating are improved.

These goals are achieved with a cooking vessel including a molded reservoir made of aluminum casting alloy, because the aluminum casting alloy used includes at least 94.5% by weight of aluminum and has a total content of between 4% and 5% by weight of the following elements: silicon, manganese, magnesium and nickel, and because the reservoir is at least partially anodized, where the thickness of the anodized layer is greater than or equal to 25 μm. Aluminum casting alloys are usually considered not to be favorable for anodizing, because of the difficulty of growing the anodic layer and/or obtaining a uniform surface appearance. Surprisingly, the anodizing of aluminum casting alloys according to the aforementioned characteristics has proven to be satisfactory for making reservoirs for cooking vessels, since these alloys make it possible to obtain an anodized layer of sufficient thickness. The reservoir thus presents hard anodizing, favorable to good scratch resistance.

Advantageously, the reservoir has an inner cooking surface with a non-stick coating, notably of PTFE. The anodic layer formed beneath the non-stick coating makes it possible to obtain a hard base which improves the scratch resistance of the non-stick coating.

According to a first embodiment, the aluminum casting alloy used includes between 3.5% and 4.2% by weight of magnesium, and preferably between 3.7% and 4.0% by weight of magnesium.

Advantageously then, the aluminum casting alloy used is an AlMg3Ti alloy including 0.25% by weight of silicon, 0.48% by weight of iron, 0.02% by weight of copper, 0.012% by weight of manganese, 3.85% by weight of magnesium and 0.07% by weight of titanium.

According to a second embodiment, the aluminum casting alloy used includes between 1.3% and 1.9% by weight of manganese and between 2.6% and 3.2% by weight of nickel, and preferably between 1.5% and 1.7% by weight of manganese and between 2.8% and 3.0% by weight of nickel.

Advantageously then, the aluminum casting alloy used is an AlMnNi alloy including 0.07% by weight of silicon, 0.19% by weight of iron, 1.6% by weight of manganese, 2.9% by weight of nickel and 0.12% by weight of titanium.

According to a third embodiment, the aluminum casting alloy used includes between 3.8% and 4.5% by weight of silicon, and preferably between 4.0% and 4.3% by weight of silicon.

Advantageously then, the aluminum casting alloy used is an AlSi4 alloy including 4.15% by weight of silicon, 0.55% by weight of iron, 0.29% by weight of manganese and 0.1% by weight of titanium.

Advantageously again, to obtain a cooking vessel compatible with induction heating, the reservoir includes at least one insert made of ferromagnetic material.

Advantageously again, the aluminum casting alloy used conforms to the European standard EN 601:2004 concerning aluminum casting alloys.

Advantageously again, the thickness of the anodized layer of the reservoir is between 25 μm and 100 μm.

Preferably the anodized layer has a Vickers hardness greater than or equal to 350 HV, in order to obtain hard anodizing.

These goals are also achieved with an item of cookware including a cooking reservoir and a gripping device mounted on said cooking reservoir, in which said cooking reservoir conforms to at least one of the aforementioned characteristics.

Then, according to one embodiment, the gripping device is attached to said cooking vessel with at least one rivet.

Then, according to another embodiment, the gripping device is assembled by screwing onto said cooking vessel.

These goals are also achieved with an electric cooking appliance including a cooking reservoir associated with heating means, in which said cooking reservoir conforms to at least one of the aforementioned characteristics.

The invention will be more fully understood in consideration of the examples, which are in way restrictive, illustrated in the attached figures, in which:

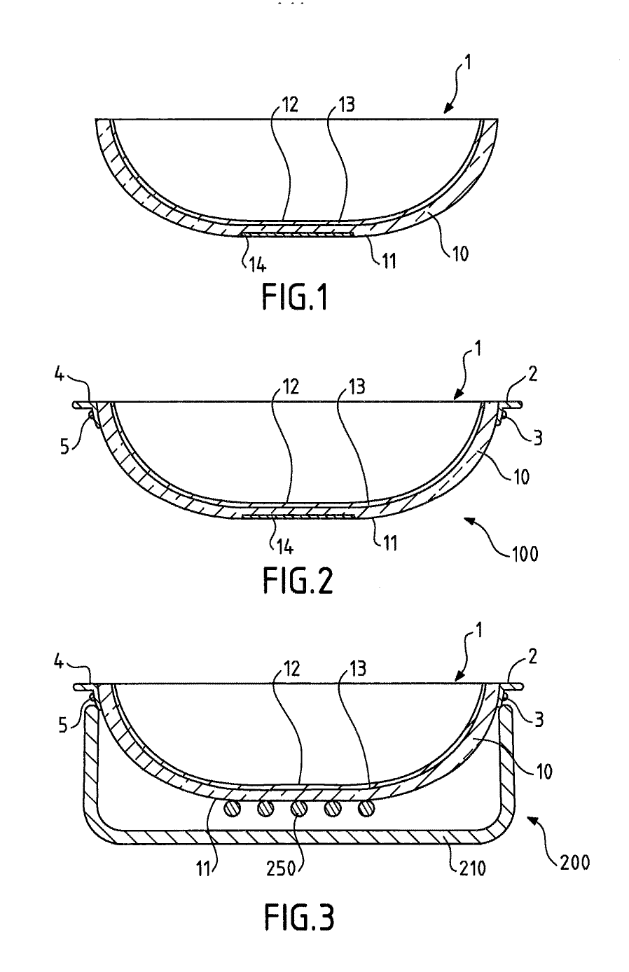

FIG. 1 illustrates a cooking vessel 1 according to the invention,

FIG. 2 illustrates an item of cookware 100 including a cooking vessel 1 according to the invention,

FIG. 3 illustrates schematically an electric cooking appliance 200 including a cooking vessel 1 according to the invention,

The cooking vessel 1 illustrated in FIG. 1 includes a molded reservoir 10 made of aluminum casting alloy. The reservoir 10 has an inner cooking surface 12 intended to receive food and an outer heating surface 11 intended to rest on a support such as for example a hot zone or an oven rack or a baking tray.

The reservoir 10 may notably be obtained using the processes of solidification between shells, or injection. A surface treatment after solidification of the reservoir 10 is necessary in order to eliminate defects; this surface treatment may notably be mechanical (brushing, sandblasting, shot blasting) or chemical (soda bath, for example).

The reservoir 10 may be at least partially coated, if desired. In the example illustrated in FIG. 1, the inner cooking surface 12 has a non-stick coating 13. The non-stick coating 13 may notably include a superficial layer of PTFE (PolyTetraFluoroEthylene). The non-stick coating 13 may notably be realized by coating. If desired, a filled PTFE may be used, in order to improve the resistance of the inner cooking surface 12. The non-stick coating 13 may extend across the entire inner cooking surface 12. The non-stick coating 13 may partially cover the inner cooking surface 12. The outer heating surface 11 is not necessarily coated. According to a preferred embodiment, the outer heating surface 11 is not coated.

If desired, the reservoir 10 may include at least one insert 14 made of ferromagnetic material, such as for example a ferritic steel, to make a cooking vessel 1 capable of being heated by induction. Preferably the ferromagnetic material is a ferritic stainless steel. If desired, the insert 14 made of ferromagnetic material may be formed of a plate having one or more perforations. The insert 14 is preferably partially covered by the die-cast aluminum alloy.

According to the invention, the aluminum casting alloy used includes at least 94.5% by weight of aluminum and has a total content of between 4% and 5% by weight of the following elements: silicon, manganese, magnesium and nickel; and the reservoir 10 is at least partially anodized, the reservoir 10 having an anodized layer with a thickness greater than or equal to 25 μm.

The aluminum casting alloy according to the invention does not necessarily include the four elements silicon, manganese, magnesium and nickel. In other words, the total content of between 4% and 5% by weight for the elements silicon, manganese, magnesium and nickel corresponds to the sum of the contents by weight of silicon, manganese, magnesium and nickel, and one, two or three of these elements may be absent from the composition of the alloy.

Preferably, the aluminum casting alloy according to the invention includes silicon. Preferably again, the aluminum casting alloy according to the invention includes manganese.

The total content of other elements is thus at most equal to 1.5% by weight. The other elements may notably include iron and/or titanium and/or copper. The total content of other elements is preferably between 0.2% and 0.8% by weight.

The insert 14 made of ferromagnetic material may notably have at least one visible part, which should be protected by masking in acid chemical baths, such as in particular anodizing bath(s). Through masking, the reservoir 10 is then partially anodized.

The anodizing treatment may notably be carried out by dipping in a bath. The anodizing of the reservoir 10 is preferably a hard anodizing leading to the formation of an anodized layer with a thickness greater than or equal to 25 μm with a Vickers hardness greater than or equal to 350 HV. Hard anodizing has the advantage of good scratch resistance and impact resistance. The thickness of the anodized layer of the reservoir 10 is preferably between 25 μm and 100 μm.

According to a first embodiment, the aluminum casting alloy used includes between 3.5% and 4.2% by weight of magnesium, and preferably between 3.7% and 4.0% by weight of magnesium. The aluminum casting alloy used is then, for example, an AlMg3Ti alloy including 0.25% by weight of silicon, 0.48% by weight of iron, 0.02% by weight of copper, 0.12% by weight of manganese, 3.85% by weight of magnesium and 0.07% by weight of titanium. An adjustment of the content of the elements of the alloy may however be envisioned by respecting the indicated magnesium content, as well as the total content of between 4% and 5% by weight for the elements silicon, manganese, magnesium and nickel.

According to a second embodiment, the aluminum casting alloy used includes between 1.3% and 1.9% by weight of manganese and between 2.6% and 3.2% by weight of nickel, and preferably between 1.5% and 1.7% by weight of manganese and between 2.8% and 3.0% by weight of nickel. The aluminum casting alloy used is then, for example, an AlMnNi alloy including 0.07% by weight of silicon, 0.19% by weight of iron, 1.6% by weight of manganese, 2.9% by weight of nickel and 0.12% by weight of titanium. An adjustment of the content of the elements of the alloy may however be envisioned by respecting the indicated contents of magnesium and nickel, as well as the total content of between 4% and 5% by weight for the elements silicon, manganese, magnesium and nickel.

According to a third embodiment, the aluminum casting alloy used includes between 3.8% and 4.5% by weight of silicon, and preferably between 4.0% and 4.3% by weight of silicon. The aluminum casting alloy used is then, for example, an AlSi4 alloy including 4.15% by weight of silicon, 0.55% by weight of iron, 0.29% by weight of manganese and 0.1% by weight of titanium. An adjustment of the content of the elements of the alloy may however be envisioned by respecting the indicated silicon content, as well as the total content of between 4% and 5% by weight for the elements silicon, manganese, magnesium and nickel.

The aluminum casting alloy used preferably conforms to the European standard EN 601:2004 concerning aluminum casting alloys for food contact.

FIG. 2 illustrates an item of cookware 100 including a cooking vessel 1 and a gripping device 2 mounted on said cooking vessel 1.

In the example illustrated in FIG. 2, the gripping device 2 is attached to the cooking vessel 1 with at least one rivet 3. For this purpose, the rivet 3 is mounted in a hole provided in the reservoir 10 of the cooking vessel 1. If desired, several rivets 3 may be used to attach the gripping device 2 to the cooking vessel 1. Preferably, between two and four rivets 3 may be used to attach the gripping device 2 to the cooking vessel 1. If desired, another gripping device 4 may be attached to said cooking vessel 1 with at least one other rivet 5 or by welding.

Alternatively, the gripping device 2 may notably be assembled by screwing onto the cooking vessel 1, for example using a screw screwed into a thread provided in the wall of the reservoir 10.

FIG. 3 illustrates an electric cooking appliance 200 including a cooking vessel 1 associated with heating means 250. The cooking vessel 1 forms a reservoir 10 arranged in a heating base 210 including the heating means 250. The outer face of the reservoir 10 rests on the heating means 250. If desired, the outer face of the reservoir 10 may be integral with the heating means 250.

This invention is in no way limited to the examples described, but encompasses numerous modifications in the context of the claims.

1. A cooking vessel including a molded reservoir made of aluminum casting alloy, wherein the aluminum casting alloy used includes at least 94.5% by weight of aluminum and has a total content of between 4% and 5% by weight of the following elements: silicon, manganese, magnesium and nickel, and wherein the reservoir is at least partially anodized, the reservoir having an anodized layer with a thickness greater than or equal to 25 μm.

2. The cooking vessel according to claim 1, wherein the reservoir has an inner cooking surface with a non-stick coating.

3. The cooking vessel according to claim 1, wherein the aluminum casting alloy used includes between 3.5% and 4.2% by weight of magnesium.

4. The cooking vessel according to claim 1, wherein the aluminum casting alloy used is an AlMg3Ti alloy including 0.25% by weight of silicon, 0.48% by weight of iron, 0.02% by weight of copper, 0.012% by weight of manganese, 3.85% by weight of magnesium and 0.07% by weight of titanium.

5. The cooking vessel according to claim 1, wherein the aluminum casting alloy used includes between 1.3% and 1.9% by weight of manganese and between 2.6% and 3.2% by weight of nickel.

6. The cooking vessel according to claim 1, wherein the aluminum casting alloy used is an AlMnNi alloy including 0.07% by weight of silicon, 0.19% by weight of iron, 1.6% by weight of manganese, 2.9% by weight of nickel and 0.12% by weight of titanium.

7. The cooking vessel according to claim 1, wherein the aluminum casting alloy used includes between 3.8% and 4.5% by weight of silicon.

8. The cooking vessel according to claim 1, wherein the aluminum casting alloy used is an AlSi4 alloy including 4.15% by weight of silicon, 0.55% by weight of iron, 0.29% by weight of manganese and 0.1% by weight of titanium.

9. The cooking vessel according to claim 1, wherein the reservoir includes at least one insert made of ferromagnetic material.

10. The cooking vessel according to claim 1, wherein the aluminum casting alloy used conforms to the European standard EN 601:2004 concerning aluminum casting alloys.

11. The cooking vessel according to claim 1, wherein the thickness of the anodized layer of the reservoir is between 25 μm and 100 μm.

12. An item of cookware including a cooking vessel according to claim 1 and a gripping device mounted on said cooking vessel.

13. The item of cookware according to claim 12, wherein the gripping device is attached to said cooking vessel with at least one rivet.

14. The item of cookware according to claim 12, wherein the gripping device is assembled by screwing onto said cooking vessel.

15. An electric cooking appliance including a cooking vessel according to claim 1 associated with a heating system.

16. The cooking vessel according to claim 3, wherein the aluminum casting alloy used includes between 3.7% and 4.0% by weight of magnesium.

17. The cooking vessel according to claim 5, wherein the aluminum casting alloy used includes between 1.5% and 1.7% by weight of manganese and between 2.8% and 3.0% by weight of nickel.

18. The cooking vessel according to claim 7, wherein the aluminum casting alloy used includes between 4.0% and 4.3% by weight of silicon.
